(19) United States
(12) Patent Application Publication
(10) Pub. No.: US 2025/0237028 A1
(43) Pub. Date: Jul. 24, 2025

(54) UNDERDRAIN SYSTEMS, DEVICES, AND METHODS

(71) Applicant: ANTHRATECH, U.S., INC., Sandy, UT (US)

(72) Inventors: Govert L. Bassett, II, Sandy, UT (US); Steve Kubler, Sandy, UT (US); Steve Lahn, Sandy, UT (US); Kelsey Selin, Sandy, UT (US); Mason White, Sandy, UT (US)

(21) Appl. No.: 19/032,633

(22) Filed: Jan. 21, 2025

Related U.S. Application Data
(60) Provisional application No. 63/624,197, filed on Jan. 23, 2024.

(51) Int. Cl. E02B 3/00; E02D 31/02; G01B 21/08

(52) U.S. Cl. CPC E02B 3/00; E02D 31/02; G01B 21/08

(57) ABSTRACT

An underdrain system includes a gasket positionable on a sealing surface and one or more underdrain laterals positionable on the gasket. At least one of the underdrain laterals has a gasket inspection hole therethrough. The gasket inspection hole is configured to: (i) have a gasket inspection tool inserted therethrough to verify that the gasket is sufficiently compressed between the sealing surface and the one or more underdrain laterals; and/or (ii) have a portion of the gasket extend therethrough when the gasket is sufficiently compressed between the sealing surface and the one or more underdrain laterals. The underdrain system may also include a gasket retention feature. Water level tests may be used to determine whether surfaces are level and/or whether relative heights are within acceptable tolerances.

### CROSS-REFERENCE TO RELATED APPLICATIONS

This application claims priority to and the benefit of U.S. Provisional Application No. 63/624,197, filed Jan. 23, 2024, and titled Process Improvements for the Installation of Filter Underdrains, the entire content of which is incorporated herein by reference.

### TECHNICAL FIELD

Embodiments of the present disclosure relate to underdrain systems. More specifically, embodiments of the present disclosure relate to systems, devices, and methods for ensuring proper installation of underdrain systems.

### BRIEF SUMMARY

Implementations of the present disclosure are directed to underdrain systems and related methods. For example, one implementation of the present disclosure is directed to an underdrain system that includes a gasket positionable on a sealing surface and one or more underdrain components positionable on the gasket. At least one of the underdrain components has a gasket inspection hole therethrough. The gasket inspection hole is configured to: (i) have a gasket inspection tool inserted therethrough to verify that the gasket is sufficiently compressed between the sealing surface and the one or more underdrain components; and/or (ii) have a portion of the gasket extend therethrough when the gasket is sufficiently compressed between the sealing surface and the one or more underdrain components.

Another example implementation is directed to an underdrain system that includes a gasket positionable on a sealing surface and one or more underdrain components positionable on the gasket. At least one underdrain component of the one or more underdrain components has a retention flange that is configured to extend down a lateral side of the gasket to limit movement of the gasket in a first direction.

Yet another example implementation is directed to a method for determining a level uniformity of and relative heights between one or more sealing surfaces and one or more high points in an underdrain system. The method includes using a water level test to determine whether a top surface of the sealing surface is level within a predetermined tolerance between opposing ends thereof. The method also includes using a water level test to determine whether the top surface of the sealing surface is level within a predetermined tolerance between opposing lateral sides thereof. Further, the method includes using a water level test to determine a height difference between the top surfaces of one or more sealing surfaces and the one or more high points in the underdrain system.

This summary is provided to introduce a selection of concepts in a simplified form that are further described below in the Detailed Description. This summary is not intended to identify key features or essential features of the claimed subject matter, nor is it intended to be used as an indication of the scope of the claimed subject matter.

Additional features and advantages of the disclosure will be set forth in the description that follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope. To facilitate understanding, like reference numerals (i.e., like numbering of components and/or elements) have been used, where possible, to designate like elements common to the figures. Specifically, in the exemplary embodiments illustrated in the figures, like structures, or structures with like functions, will be provided with similar reference designations, where possible. The disclosure will be described and explained with additional specificity and detail through the use of the accompanying drawings in which:

FIG. 1 illustrates a perspective, partial section view of an underdrain system according to an example embodiment of the present disclosure;

FIG. 2 illustrates a cross section view of a portion of the underdrain system of FIG. 1;

FIG. 3 illustrates a perspective view of an underdrain lateral according to an example embodiment of the present disclosure;

FIGS. 4A and 4B illustrate perspective and cross section views of installation aspects of an underdrain lateral according to an example embodiment of the present disclosure; and

FIG. 5A and B illustrate testing procedures according to example embodiments of the present disclosure for determining that one or more sealing surfaces are level and one or more high points are at desired relative heights to the sealing surfaces.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

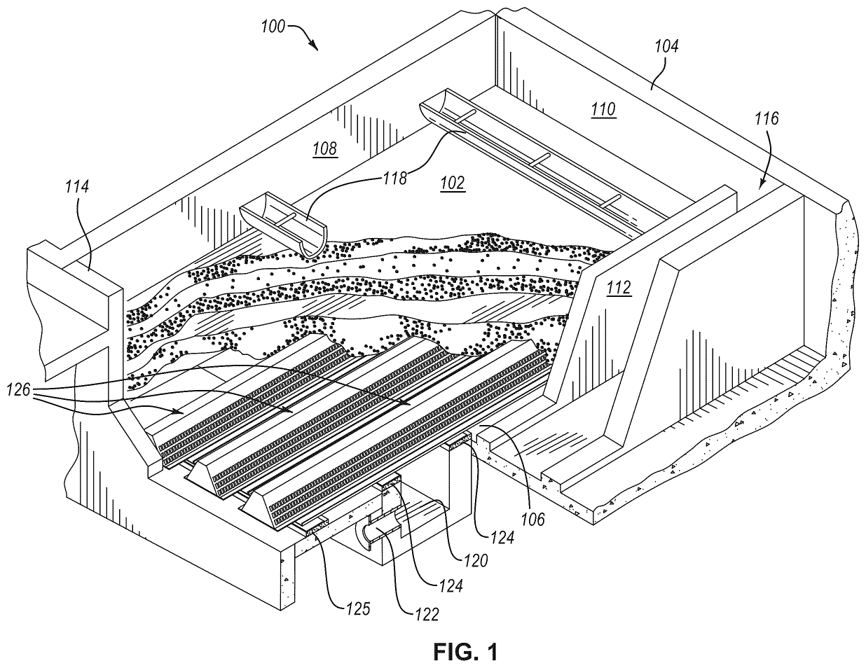

With reference to FIG. 1, a granular media filter system 100 (also referred to as filter system 100 or system 100) according to an example embodiment is illustrated. As shown, the filter system 100 includes a bed 102 of filter media, In the illustrated embodiment, the bed 102 includes multiple lays of different types of filter media. Such layers may include a layer of anthracite coal, a layer of granular activated carbon, a layer of sand, a layer of garnet sand, a layer of manganese removal material, and/or one or more layers of gravel. In some embodiments, the one or more layers of gravel may include multiple layers of gravel that get progressively coarser towards the bottom of the bed 102.

It will be appreciated that the configuration and type of filter media used for the bed 102 may vary from one embodiment to another. For instance, in some embodiments, no gravel layers are used. Similarly, one or both of the anthracite coal and/or sand layers may be omitted or replaced with other filter media. In some embodiments, a layer of fine heavy material, such as garnet or ilmenite, is disposed under the layer of sand. Other filter media that may be used in the bed 102 include, merely by way of example, manganese dioxide, activated carbon, etc.

The bed 102 is located in a basin 104, typically made of concrete. The basin 104 includes a bottom slab 106 and walls 108, 110, 112, 114. An overflow trough 116 may be formed adjacent to the basin 104. The overflow trough 116 may be configured to receive backwash water from troughs 118. For instance, if the basin 104 fills with water to a height that is above the troughs 118, the water may flow into the troughs 118 and into the trough 116. The troughs 118 may extend transversely across the basin 104 and above the bed 102.

A transversely extending flume 120 is provided in the bottom of the basin 104. In the illustrated embodiment, the flume 120 is shown positioned in the middle of the basin 104. In other embodiments, the flume 120 may be positioned at one end of the basin 104. In still other embodiments, the flume 120 may be positioned at another location in or adjacent to the basin 104. Further, some embodiments may include multiple flumes 120. In any case, the flume(s) 120 may be configured for receiving filtered and backwash water. Filtered water is discharged from the flume 120 via a pipe 122. The pipe 122 may also be used to introduce backwash water into the basin 104.

While the system 100 is illustrated with a basin 104 that has a flume 120 in the floor thereof, it will be appreciated that this is only one example embodiment. The systems, components, and concepts disclosed herein may be used with or modified for use with other types of underdrain systems, including, for instance, ported wall or curtain wall configurations.

A sealing surface 124 is disposed around the flume 120. In the illustrated embodiment, the sealing surface 124 is comprised of a grout seal strip 124 disposed on and extending upwardly from the bottom slab 106. The grout seal strip 124 may have a width of between about 1 inch to about 12 inches, between about 1 inch and about 6 inches, between about 2 inches and about 4inches, or any width at or between any of the noted dimensions. Similarly, the grout seal strip 124 may have a height of between about 1 inch to about 6 inches, between about 1 inch and about 4 inches, between about 1 inch and about 2 inches, or any height at or between any of the noted dimensions.

The sealing surface 124 may be configured to support one or more underdrain components 126. The underdrain components 126 may take various forms. For instance, in the illustrated embodiment, the underdrain components 126 are underdrain laterals (also referred to herein as laterals 126). In other embodiments, the underdrain components 126 may include feedplates, feedboxes, air distribution boxes, and the like. The underdrain components 126 may also include mounting plates for laterals, feedplates, feedboxes, air distribution boxes, and the like. The mounting plates may be integrally formed with the laterals, feedplates, feedboxes, or air distribution boxes, or they may be separate therefrom and/or selectively or permanently attachable together. Accordingly, while the illustrated embodiments are in the context of laterals, it will be understood that this is provided merely as an example and the principles of the present disclosure may be practiced with other underdrain components.

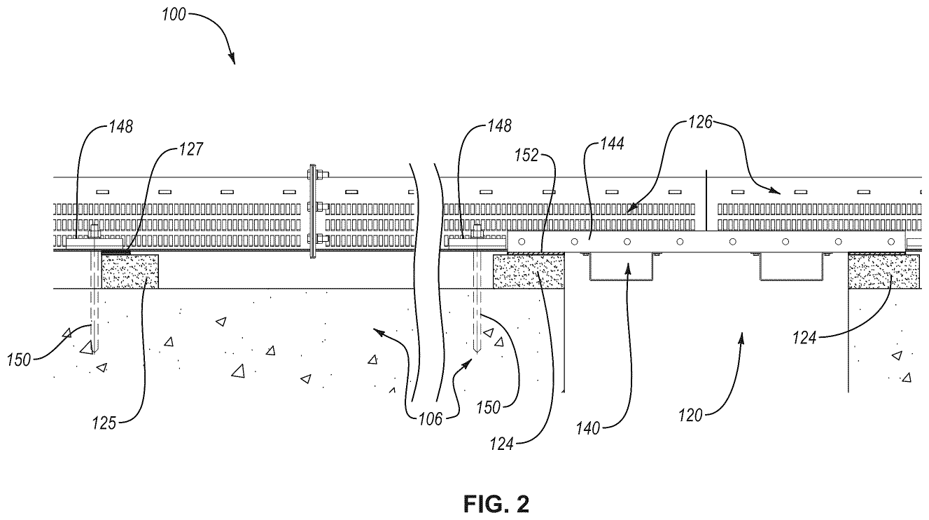

The laterals 126 may include multiple laterals 126 that are arranged in adjacent rows, as shown. In some embodiments, each row includes a single lateral 126 that extends the entire length of the basin 104. In other embodiments, one or more of the rows may include multiple lateral sections that are connected together end-to-end to form a single lateral as shown in FIG. 2.

As shown in FIG. 1 and the cross-sectional view of FIG. 2, the laterals 126 may extend over the bottom slab 106 and the flume 120. The laterals 126 may rest on the grout seal strips 124 on opposing sides of the flume 120. Additionally, in some embodiments, such as shown in FIG. 2, the basin 104 may also include one or more leveling strips 125 disposed on the bottom slab 106. The leveling strips 125 may be similar to the grout seal strips 124. The leveling strips 125 may be spaced apart from the grout seal strips 124 and may not surround a flume 120. However, the leveling strips 125 may be configured to support the laterals 126. As such, the grout seal strips 124 and the leveling strips 125 may be configured to hold the laterals 126 level or at a desired orientation,

Positioning the laterals 126 on the grout seal strips 124 and leveling strips 125 may make it easier to hold the laterals 126 level or at a desired orientation compared to positioning the laterals 126 directly on the bottom slab 106. However, it will be appreciated that embodiments of the present disclosure may not require grout seal strips 124 and leveling strips 125. Rather, the laterals 126 may be positioned on any appropriate sealing surface. In some embodiments, the sealing surface 124 may be portions of the surface of the bottom slab 106. Similarly, one or more high points on the surface of the bottom slab 106 may also function similar to the leveling strips 125.

In some embodiments, the leveling strips 125 may have widths and/or heights that are similar to the widths and/or heights of the grout seal strips 124. In other embodiments, such as shown in FIG. 2, the leveling strips 125 may have a height that is lower than the height of the grout seal strips 124. For instance, the leveling strips 125 may have a height that is ⅛ inch lower than the grout seal strips 124. This may be done to allow for some tolerance within the system 100. For instance, instead of having to ensure that the leveling strips 125 are at the same height as and level with the grout seal strips 124, the leveling strips 125 may be intentionally made shorter. Then, when installing the laterals 126, one or more shims 127 may be positioned between the leveling strips 125 and the laterals 126 to bring the laterals 126 to the desired height,

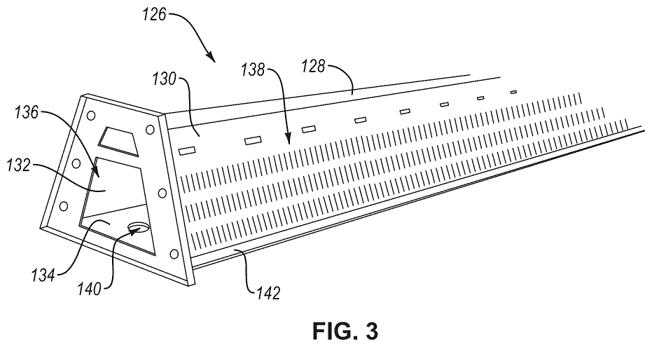

With continued attention to FIGS. 1 and 2, attention is also now directed to FIG. 3. FIG. 3 illustrates a perspective view of a portion of a lateral 126 according to one example embodiment, In the illustrated embodiment, the lateral 126 has a generally trapezoidal profile formed by a top wall 128, side walls 130, 132, and a bottom wall 134. As shown, the top wall 128 and the bottom wall 134 are parallel to one another and the side walls 130, 132 are angled relative to one another such that the top wall 128 is narrower than the bottom wall 134. The top wall 128, the side walls 130, 132, and the bottom wall 134 cooperate to form a channel 136 through the lateral 126.

The side walls 130, 132 have apertures 138 formed therein. The apertures 138 may have a variety of shapes and may be arranged in various regular or irregular patterns. In the illustrated embodiment, the apertures 138 are arranged in multiple rows, with each row including a plurality of evenly spaced apertures 138. Regardless of their specific shape or arrangement, the apertures 138 may be configured to allow water to pass therethrough while also preventing the filter media of the bed 102 from passing therethrough. For instance, the apertures 138 may be sized small enough to prevent the filter media from passing therethrough while also being large enough to allow for water to pass therethrough.

The bottom wall 134 may include one or more openings 140 formed therein. The opening 140 may be configured to allow water within the channel 136 to flow out of the lateral 126. For instance, as shown in FIG. 2, when the lateral 126 is properly installed within the filter system 100, the opening 140 may be positioned over the flume 120 such that water may flow out of the channel 136 through the opening 140 and into the flume 120 during a water filtering operation. Similarly, during a backwash operation, water may be pumped or flow by gravity from an elevated storage tank through the flume 120 and into the channel 136 in lateral 126 through the opening 140. The backwash water may then exit the lateral 126 through the apertures 138.

As shown, the lateral 126 may include a flange 142 extending along at least a portion of the length thereof. In some embodiments, the lateral 126 includes a flange 142 on each side thereof. The flange(s) 142 may be formed by the bottom wall 134 (e.g., by having the bottom wall 134 extend laterally beyond the lower edge(s) of the side wall(s) 130, 132. In other embodiments, the lower portions of the side wall(s) 130, 132 may be angled outwardly to form the flange(s) 142. In still other embodiments, the bottom wall 134 and the side wall(s) 130, 132 may cooperate to form the flange(s) 142. In still other embodiments, the flange(s) may be attached to the bottom wall 134 and/or the side wall(s) 130, 132 (e.g., via welding, etc.). Regardless, as discussed in more detail below, the flange(s) 142 may be configured to facilitate mounting of the laterals 126 within the filter system 100.

While the laterals 126 are illustrated as having a trapezoidal profile, this is merely exemplary. The laterals 126 may have other profiles. For instance, the laterals may have a triangular profile, with a bottom wall and side walls that meet at an upper end (similar to the laterals 126, except without the top wall 128 and the upper edges of the side walls 130, 132 meeting each other). In other embodiment, the laterals may have a rectangular profile. In such a case, the side walls may include apertures (similar to apertures 138). Additionally, or alternatively, a top wall may include apertures that allow water to flow into or out of the lateral,

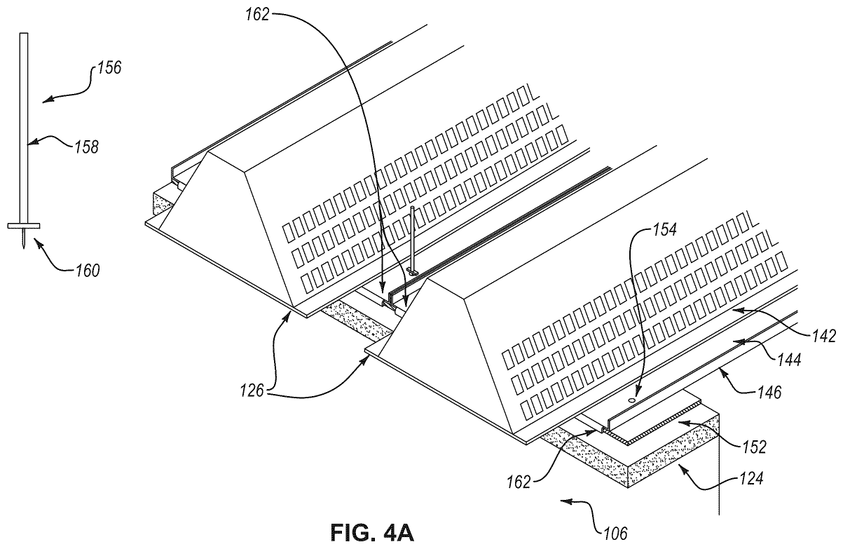

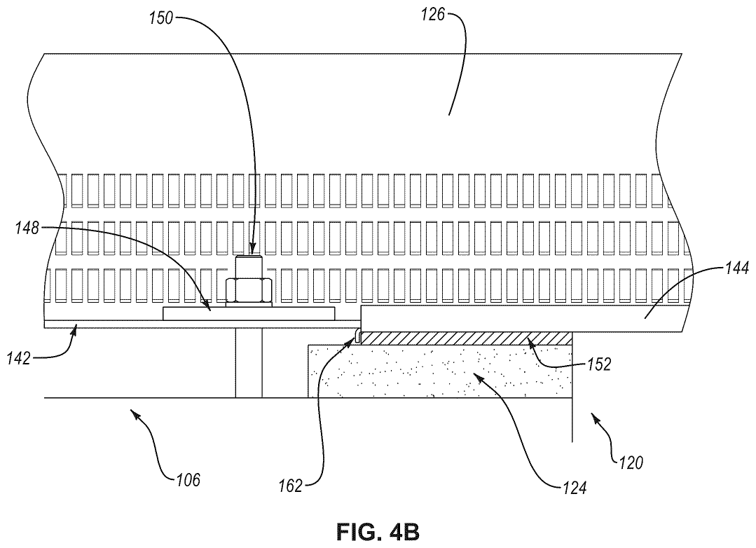

Attention is now directed to FIGS. 4A and 4B, which illustrate aspects of installing the laterals 126 on the grout seal strips 124. As shown, each lateral 126 has one or more mounting plates 144 attached thereto or integrally formed therewith. For instance, each mounting plate 144 may be attached to the bottom wall 134 and/or to the flanges 142 of a lateral 126. In some embodiments, the mounting plates 144 are welded to the flanges 142 of the laterals 126. While the mounting plates 144 typically only extend along a portion of the length of the laterals 126 (e.g., adjacent an end of the lateral 126), the mounting plates 144 may extend along the entire length of the laterals 126.

The mounting plates 144 may include flanges 146 that facilitate connection between adjacent laterals 126. In the illustrated embodiments, the flanges 146 extend upwardly. The flanges 146 may include apertures therethrough that are configured to receive fasteners. During installation, the mounting plates 144 of adjacent laterals 126 may be positioned adjacent to one another with the apertures aligned. One or more fasteners (e.g., bolts and nuts) may be used to secure the flanges 146 together via the apertures. Securing the flanges 146 together in turn secures the laterals 126 together,

As shown in FIG. 4B (and FIG. 2), the laterals 126 may be further secured in place by securing them to the bottom slab 106. For instance, hold down clamps 148 and fasteners 150 may be used to secure the laterals 126 to the bottom slab 106. In the illustrated embodiment, a portion of the hold down clamp 148 may extend over a portion of the flange 142 and/or the mounting plate 144. A fastener 150 may extend through the hold down clamp 148 and into the bottom slab 106, thereby applying a downward force to the hold down clamp 148 and the lateral 126 to hold the lateral 126 in place. As shown in FIG. 2, hold down clamps 148 and fasteners 150 may also be used adjacent to the leveling strips 125 to secure the laterals 126 to the bottom slab 106.

To help prevent filter media from the bed 102 from passing between the grout seal strip 124 and the underside of the laterals 126 and into the flume 120, a gasket 152 may be positioned between the grout seal strip 124 and the underside of the laterals 126 or mounting plates 144, as shown in FIGS. 4A and 4B. The gasket 152 may be configured to form a watertight or other seal between the grout seal strip 124 and the underside of the laterals 126 or mounting plates 144.

The gasket 152 may be formed of a compressible material such that the gasket 152 can conform to the top surface of the grout seal strip 124 and the underside of the laterals 126 or mounting plates 144. In some embodiments, it may be desirable to compress the gasket 152 a certain amount to ensure that an adequate seal is formed between the grout seal strip 124 and the laterals 126 or mounting plates 144. For instance, in some embodiments, it may be desirable to ensure that the gasket 152 is compressed by about 10%, about 20%, about 30%, about 40%, about 50%, about 60%, about 70%, about 80%, about 90%, or any amount between any of the noted values. The amount of compression may be controlled by the hold down clamp 148 and the fastener 150. The fastener 150 may include an anchor that is set in the bottom slab 106 and a nut. To increase the compression on the gasket 152, the anchor may be driven further into the slab 106 or the nut may be threaded further onto the anchor. In either case, the force on the hold down clamp 148 may be increased, which will translate to additional compression on the gasket 152.

With underdrain systems, it can be difficult or impossible to directly observe whether the gasket is sufficiently compressed because the laterals block the view of the gaskets. To remedy this challenge and ensure that the gasket 152 has been sufficiently compressed, the flanges 142 and/or mounting plates 144 may include one or more inspection holes 154 therethrough. For instance, as shown in FIG. 4A, each mounting plate 144 includes an inspection hole 154. As shown, when the laterals 126 are installed, the inspection holes 154 may be positioned over the center (about equidistant from opposing lateral or long sides) of the gasket 152. In other embodiments, the inspection holes 154 may be positioned closer to one lateral or long side of the gasket 152 than the other. In still other embodiments, multiple inspection holes 154 may be included in a flange 142 and/or mounting plate 144. In cases with two inspection holes 154, the inspection boles 154 may be arranged so as to be spaced equal distances from lateral or long sides (and optionally offset from the center) of the gasket 152 when the lateral 126 is properly positioned on the grout seal strip 124. In other embodiments, three inspection holes 154 may be included, with one positioned so as to be adjacent to a first side of the gasket 152, a second one centered over the gasket 152, and a third positioned adjacent to a second side of the gasket 152 when the lateral is properly installed. Including multiple inspection holes 154 may allow for an assessment of the gasket 152 compression between at various points between opposing sides thereof. This may be useful to ensure that the entire width of the gasket 152 is sufficiently compressed,

The inspection holes 154 may be used to assess the level of gasket 152 compression in various ways. For instance, as the gasket 152 is compressed, some of the gasket 152 may extend through the inspection holes 154. Depending on the size of the inspection holes 154 and/or the material used for the gasket 152, the level of compression of the gasket 152 may be determined by how much of the gasket 152 extends through the inspection holes 154.

Alternatively, as shown in FIG. 4A, an inspection tool 156 may be used to assess the level of compression of the gasket 152. As shown, the inspection tool 156 may include a shaft 158 and a depth gauge 160. In the illustrated embodiment, the shaft 158 extends in opposing directions relative to the depth gauge 160. In other embodiments, the shaft 158 may extend in only one direction relative to the depth gauge 160. In some embodiments, a lower end of the shaft 158 may be tapered or otherwise shaped to facilitate insertion thereof into the gasket 152 as described below. The depth gauge 160 may be positioned at a predetermined distance from the distal end of the lower end of the shaft 158. In some embodiments, the predetermined distance is fixed and in other embodiments it is adjustable. The predetermined distance may be equal to the sum of: (i) the desired thickness of the gasket 152 when compressed the desired amount, (ii) the thickness of the mounting plate 144 and/or flange 142, and, optionally, (iii) an offset. As described below, the offset may help provide an indication that the gasket 152 has been sufficiently, but not overly, compressed.

The inspection tool 156 may be inserted into the inspection holes 154 to determine whether the gasket 152 has been sufficiently compressed. By way of example, assume that the gasket 152 has a non-compressed thickness of ⅜ inches and a 50% compression is desired. In such a situation, the inspection tool 156 may be used to confirm whether the gasket 152 has been compressed to 3/16 inches. To assess the level of compression, the lower end of the inspection tool 156 may be inserted into the inspection hole 154. How far the inspection tool 156 is able to extend through the inspection hole 154 and into the gasket 152 will indicate how much compression of the gasket 152 has been achieved. If the depth gauge 160 engages the mounting plate 144 before the lower end of the shaft 158 engages the grout seal strip 124, the installer will know that sufficient compression has not been achieved. The installer can then tighten the nut of the fastener 150 or drive the anchor of the fasteners 150 further into the bottom slab 106, which will cause the hold down clamps 148 to apply additional compressive force to the laterals 126. Additional compressive force from the laterals 126 will result in additional compression of the gasket 152.

In contrast, if the lower end of the shaft 158 engages the grout seal strip 124 well before the depth gauge 160 approaches the mounting plate 144 (e.g., the distance between the mounting plate 144 and the depth gauge 160 is greater than the offset), the installer will know that the gasket 152 has been over-compressed. To remedy this, the installer can loosen the nuts of the fastener 150 or partially withdraw the anchor of the fasteners 150, thereby reducing the compressive force from the hold down clamps 148 and the compression of the gasket 152.

In further contrast, if the lower end of the shaft 158 engages the grout seal strip 124 when the depth gauge 160 is adjacent to the mounting plate 144, the installer will know that the gasket 152 has been sufficiently, but not overly compressed. The depth gauge 160 may be considered to be adjacent to the mounting plate 144 when the distance therebetween is about the distance of the offset or less. In some embodiments, the offset may be about ⅕ inches, about ¼ inches, about ⅛ inch, about 1/16 inch, about 1/32 inch, or any value therebetween. In still other embodiments, the offset may be some proportion or percentage of the thickness of the gasket.

Once the desired level of compression for the gasket 152 is achieved, the inspection tool 156 may be removed. In some embodiments, the inspection tool 156 may be used in multiple inspection holes 154 to determine the level of compression of the gasket 152 at multiple locations. In other embodiments, the inspection tool 156 may be left in the inspection hole 154. In such an embodiment, the depth gauge 160 may act as a cap to the inspection hole 154 so as to protect the portion of the gasket 152 that would otherwise be exposed through the inspection hole 154.

FIGS. 4A and 4B also illustrate features for helping retain the gasket 152 in place between the grout seal strip 124 and the laterals 126. During typical water filtering operations, the water flowing through the system 100 may apply a lateral pressure to the gasket 152. While the lateral pressure may be in a direction that would tend to urge the gasket 152 out from between the grout seal strip 124 and the laterals 126 and towards the flume 120, the lateral pressure is usually low enough so as not to be able to actually dislodge the gasket 152 from its place. However, during a backwash operation, the lateral pressure experienced by the gasket 152 (in a direction away from the flume 120) may be significantly higher. To help ensure that the gasket 152 is not dislodged, one or more retention features may be included.

For instance, as shown in FIGS. 4A and 4B, the mounting plates 144 may include a retention flange 162. The retention flange 162 may extend down a side of the gasket 152 that is positioned away from the flume 120. The retention flange 162 may extend a portion of the entire way between a top surface of the mounting plate 144 and the grout seal strip 124 when fully installed. In some embodiments, the retention flanges 162 are integrally formed with the mounting plates 144. In other embodiments, the retention flanges 162 may be formed separate from the mounting plates 144 and may be attached thereto (e.g., via welding, fasteners, etc.).

The retention flange 162 may be configured to hold the gasket 152 in place laterally. For instance, during a backwash operation, the lateral pressure on the gasket 152 may increase. Even if the lateral pressure increases to a level that would otherwise cause the gasket to move laterally and become dislodged from between the grout seal strip 124 and the laterals 126, the retention flange 162 may hold the gasket 152 in place and prevent it from becoming dislodged. By holding the gasket 152 in place with the retention flange 162, the seal between the grout seal strip 124 and the laterals 126 can be maintained. As a result, filter media from the bed 102 will not be able to pass therebetween and into the flume 120 during subsequent filtering operations.

In some embodiments, the mounting plates 144 may also or alternatively include retention flanges that extend down the side of the gasket 152 that is positioned adjacent to the flume 120. Such a retention flange may prevent the gasket 152 from becoming dislodged in the direction of the flume 120 if the water pressure during filtering operations increased beyond normal levels.

In some cases, the retention flanges may act as depth gauges to indicate when the gasket 152 has been sufficiently compressed. For instance, the height of the retention flanges may be set so that the lower ends thereof will engage the grout seal strip 124 when the gasket 152 is sufficiently compressed. If the lower end of the retention flanges do not engage the grout seal strip 124, the installer may know that the gasket 152 has not been sufficiently compressed.

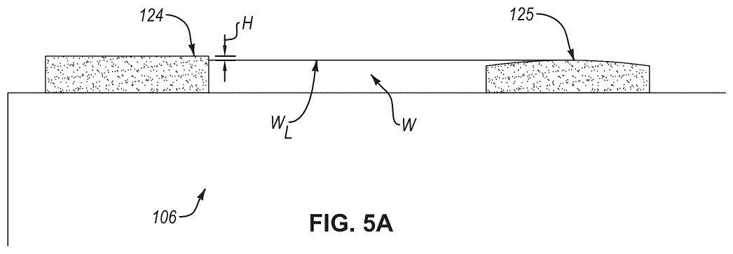

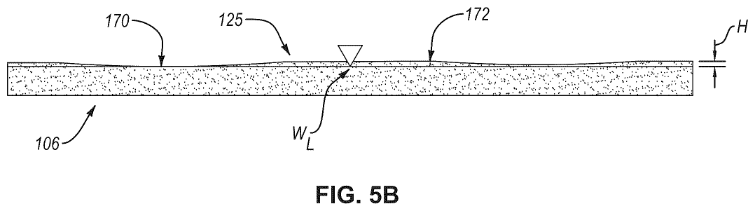

Attention is now directed to FIG. 5A and 5B, which illustrate example manners in which the grout seal strip 124 and/or the leveling strips 125 can be checked for level across their lengths and widths and their heights relative to one another. Ensuring that the grout seal strips 124 and the leveling strips 125 are level across their lengths and widths can help ensure that the laterals 126 can be installed level and with adequate sealing between the laterals 126 and the grout seal strips 124. Additionally, ensuring that the leveling strips 125 are the same height as or shorter than the grout seal strips 124 can further help ensure that the laterals 126 are installed level (with the help of the shims 127).

FIG. 5A illustrates one level test that may be performed. The level test of FIG. 5A can be used to determine whether the leveling strip 125 is level across its width. The level test of FIG. 5A may also be used to determine whether the height of the leveling strip 125 is at or below (but within a predetermined tolerance) of the height of the grout seal strip 124.

In particular, after the grout seal strips 124 and the leveling strips 125 have been installed on the bottom slab 106 of the basin 104, water W can be added to the basin 104. The water level WL can be increased up to the top of the leveling strips 125. As shown in FIG. 5A, when the water level WL is brought up to the top of the leveling strip 125, water W covering a portion of the leveling strip 125 indicates that the leveling strip 125 has a high point. In the illustrated embodiment, the high point is shown as a hump in the middle of the leveling strip 125. In other cases, the high point may be towards one side of the leveling strip 125 (e.g., in the case of the top surface of the leveling strip 125 being slanted to one side). If the top surface of the leveling strip 125 is not sufficiently level as determined by this water level test, the leveling strip 125 may be modified (e.g., top surface ground level) or replaced. A similar test may be used to determine whether the top surface of the grout seal strip 124 is level between its opposing sides.

As also shown in FIG. 5A, the water level WL can also be used to determine the relative height difference between the grout seal strip 124 and the leveling strip 125. More specifically, the water level WL can be raised to the top of the leveling strip 125. The height different H can be measured to ensure that the leveling strip 125 is lower than the height of the grout strip 124, and optionally within a desired tolerance (e.g., ⅛ inch). The height difference H can be determined by measuring the height of the portion of the grout seal strip 124 that is above the water level WL.

The test to determine whether the leveling strip 125 is level between its opposing sides and the relative heights of the leveling strip 125 and the grout seal strip 124 can be performed simultaneously or separately.

FIG. 5B illustrates another level test that may be used to determine whether grout seal strip 124 and/or the leveling strip 125 is/are level between opposing ends thereof. FIG. 5B illustrates the test being performed for the leveling strip 125. It will be appreciated that the same test may be performed for the grout seal strip 124.

The test can be performed after the leveling strip 125 had been installed on the bottom slab 106. To perform the test, water W may be added to the basin 104. The water level WL may be increases until it reaches the lowest point 170 on the upper surface of the leveling strip 125, as shown in FIG. 5B. A height different H can be measured between the water level WL and the highest point 172 on the upper surface of the leveling strip 125. The height difference H can indicate whether the leveling strip 125 is sufficiently level between its opposing ends. For instance, if the height difference H is within a desired tolerance (e.g., ⅛ inch), the leveling strip 125 may be considered sufficiently level. A similar test may also be performed to determine whether the grout sealing strip 124 is sufficiently level between its opposing ends. If the grout seal strips 124 and/or the leveling strips 125 are determined to not be sufficiently level between their opposing ends, remedial actions can be taken (e.g., the top surfaces can be ground down to be level or the strips can be removed and replaced).

Following are some further example embodiments of the invention. These are presented only by way of example and are not intended to limit the scope of the invention in any way. Further, any example embodiment can be combined with one or more of the example embodiments.

Embodiment 1: An underdrain system, comprising: a gasket positionable on a grout seal strip or sealing surface; and one or more underdrain components positionable on the gasket, at least one underdrain component of the one or more underdrain components having a gasket inspection hole therethrough, the gasket inspection hole being configured to: have a gasket inspection tool inserted therethrough to verify that the gasket is sufficiently compressed between the grout seal strip or sealing surface and the one or more underdrain components; and/or have a portion of the gasket extend therethrough when the gasket is sufficiently compressed between the grout seal strip or sealing surface and the one or more underdrain components.

Embodiment 2: The underdrain system of Embodiment 1, wherein the at least one underdrain component comprises a lateral comprising one or more mounting plates.

Embodiment 3: The underdrain system of Embodiment 2, wherein the gasket inspection hole extends through at least one mounting plate of the one or more mounting plates.

Embodiment 4: The underdrain system of Embodiment 2, wherein at least one mounting plate of the one or more mounting plates comprises a flange that is configured to be connected to a flange of a mounting plate of another underdrain lateral.

Embodiment 5: The underdrain system of Embodiment 2, wherein at least one mounting plate of the one or more mounting plates comprises a retention flange that is configured to extend down a lateral side of the gasket to hold the gasket in place.

Embodiment 6: The underdrain system of Embodiment 5, wherein the at least one mounting plate comprises a second retention flange configured to extend down a second lateral side of the gasket to hold the gasket in place.

Embodiment 7: The underdrain system of Embodiment 1, further comprising an inspection too comprising a shaft and a depth gauge, a lower end of the shaft being configured to be inserted into the gasket inspection hole and the depth gauge being configured to indicate whether the gasket has been compressed a desired amount.

Embodiment 8: The underdrain system of Embodiment 1, wherein the at least one underdrain component comprises one or more flanges configured to facilitate attachment of the at least one underdrain component to an underdrain basin.

Embodiment 9: The underdrain system of Embodiment 8, wherein the gasket inspection hole extends through at least one flange of the one or more flanges.

Embodiment 10: An underdrain system, comprising: a gasket positionable on a grout seal strip or sealing surface; and one or more underdrain components positionable on the gasket, at least one underdrain component of the one or more underdrain components having a retention flange that is configured to extend down a lateral side of the gasket to limit movement of the gasket in a first direction.

Embodiment 11: The underdrain system of Embodiment 10, wherein the at least one underdrain components comprises a mounting plate.

Embodiment 12: The underdrain system of Embodiment 11, wherein the retention flange is attached to or integrally formed with the mounting plate.

Embodiment 13: The underdrain system of Embodiment 10, wherein at least one underdrain component comprises a second retention flange configured to extend down a second lateral side of the gasket to limit movement of the gasket in a second direction.

Embodiment 14: The underdrain system of Embodiment 13, wherein the second retention flange is attached to or integrally formed with a mounting plate of the at least one underdrain component.

Embodiment 15: The underdrain system of Embodiment 10, wherein the at least one underdrain component comprises a gasket inspection hole extending therethrough and configured for use in assessing a level of compression of the gasket.

Embodiment 16: The underdrain system of Embodiment 15, wherein the gasket inspection hole is configured to: have a gasket inspection tool inserted therethrough to verify that the gasket is sufficiently compressed between the grout seal strip or sealing surface and the at least one underdrain component; and/or have a portion of the gasket extend therethrough when the gasket is sufficiently compressed between the grout seal strip or sealing surface and the at least one underdrain component.

Embodiment 17: A method for determining a level uniformity of and relative heights between a gasket sealing surface and a leveling strip or high point in an underdrain system, the method comprising: using a water level test to determine whether a top surface of the gasket sealing surface is level within a predetermined tolerance between opposing ends thereof; using a water level test to determine whether the top surface of the gasket sealing surface is level within a predetermined tolerance between opposing lateral sides thereof; and using a water level test to determine a height difference between the top surfaces of the gasket sealing surface and the leveling strip or high point.

Embodiment 18: The method of Embodiment 17, wherein using a water level test to determine whether the top surface of the leveling strip is level within a predetermined tolerance between opposing ends thereof comprises: adding water to an underdrain basin until the water level reaches the lowest point on the top surface of the leveling strip; determining a height difference between the lowest point and a highest point on the top surface of the leveling strip; and determining whether the height difference is within a predetermined tolerance.

Embodiment 19: The method of Embodiment 17, wherein using a water level test to determine whether the top surface of the leveling strip is level within a predetermined tolerance between opposing lateral sides thereof comprises: adding water to an underdrain basin until the water level reaches the highest point on the top surface of the leveling strip; determining whether the water covers a portion of the top surface of the leveling strip; and determining whether the covered portion is within a predetermined tolerance.

Embodiment 20: The method of Embodiment 17, wherein using a water level test to determine a height difference between the top surfaces of the leveling strip and the grout seal strip comprises: adding water to an underdrain basin until the water level reaches the top surface of the leveling strip; determining a height difference between the top surface of the leveling strip and the top surface; and determining whether the height difference is within a predetermined tolerance.

As envisioned, the features described herein may be employed individually or in various combinations in a filter underdrain installation.

In some embodiments, any of the foregoing elements for assembling, modifying, and/or improving underdrains may be provided as a kit.

Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the terms “example” and “exemplary” mean “serving as an example, instance, or illustration,” and should not necessarily be construed as preferred or advantageous over other embodiments disclosed herein.

It will be noted that, as used in this specification and the appended claims, the singular forms “a,” “an” and “the” include plural referents unless the context clearly dictates otherwise. Thus, for example, reference to a singular referent (e.g., “widget”) includes one, two, or more referents. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent” and the like are used herein solely to indicate relative directions and are not otherwise intended to limit the scope of the disclosure and/or claimed invention.

Various aspects of the present disclosure can be illustrated by describing components that are bound, coupled, attached, connected, and/or joined together. As used herein, the terms “bound,” “coupled”, “attached”, “connected,” and/or “joined” are used to indicate either a direct association between two components or, where appropriate, an indirect association with one another through intervening or intermediate components.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, devices, products, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects, however, are also contemplated herein.

The present disclosure may be embodied in other specific forms without departing from its spirit or essential characteristics. The described embodiments are to be considered in all respects only as illustrative and not restrictive. The scope of the invention, therefore, is indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. An underdrain system, comprising:
a gasket positionable on a sealing surface; and
one or more underdrain components positionable on the gasket, at least one underdrain component of the one or more underdrain components having a gasket inspection hole therethrough, the gasket inspection hole being configured to:
have a gasket inspection tool inserted therethrough to verify that the gasket is sufficiently compressed between the grout seal strip and the one or more underdrain components; and/or
have a portion of the gasket extend therethrough when the gasket is sufficiently compressed between the grout seal strip and the one or more underdrain components.

2. The underdrain system of claim 1, wherein the at least one underdrain component comprises a lateral comprising one or more mounting plates.

3. The underdrain system of claim 2, wherein the gasket inspection hole extends through at least one mounting plate of the one or more mounting plates.

4. The underdrain system of claim 2, wherein at least one mounting plate of the one or more mounting plates comprises a flange that is configured to be connected to a flange of a mounting plate of another underdrain lateral.

5. The underdrain system of claim 2, wherein at least one mounting plate of the one or more mounting plates comprises a retention flange that is configured to extend down a lateral side of the gasket to hold the gasket in place.

6. The underdrain system of claim 5, wherein the at least one mounting plate comprises a second retention flange configured to extend down a second lateral side of the gasket to hold the gasket in place.

7. The underdrain system of claim 1, further comprising an inspection tool comprising a shaft and a depth gauge, a lower end of the shaft being configured to be inserted into the gasket inspection hole and the depth gauge being configured to indicate whether the gasket has been compressed a desired amount.

8. The underdrain system of claim 1, wherein the at least one underdrain component comprises one or more flanges configured to facilitate attachment of the at least one underdrain component to a filter basin.

9. The underdrain system of claim 8, wherein the gasket inspection hole extends through at least one flange of the one or more flanges.

10. An underdrain system, comprising:
a gasket positionable on a sealing surface; and
one or more underdrain components positionable on the gasket, at least one underdrain component of the one or more underdrain components having a retention flange that is configured to extend down a lateral side of the gasket to limit movement of the gasket in a first direction.

11. The underdrain system of claim 10, wherein the at least one underdrain component comprises a mounting plate.

12. The underdrain system of claim 11, wherein the retention flange is attached to or integrally formed with the mounting plate.

13. The underdrain system of claim 10, wherein at least one underdrain component comprises a second retention flange configured to extend down a second lateral side of the gasket to limit movement of the gasket in a second direction.

14. The underdrain system of claim 13, wherein the second retention flange is attached to or integrally formed with a mounting plate of the at least one underdrain component.

15. The underdrain system of claim 10, wherein the at least one underdrain components comprises a gasket inspection hole extending therethrough and configured for use in assessing a level of compression of the gasket.

16. The underdrain system of claim 15, wherein the gasket inspection hole is configured to:
have a gasket inspection tool inserted therethrough to verify that the gasket is sufficiently compressed between the sealing surface and the at least one underdrain component; and/or
have a portion of the gasket extend therethrough when the gasket is sufficiently compressed between the sealing surface and the at least one underdrain component.

17. A method for determining a level uniformity of and relative heights between a gasket sealing surface and a leveling strip or a high point in a floor of a filter system, the method comprising:
using a water level test to determine whether a top surface of the gasket sealing surface is level within a predetermined tolerance between opposing ends thereof;
using a water level test to determine whether the top surface of the gasket sealing surface is level within a predetermined tolerance between opposing lateral sides thereof; and
using a water level test to determine a height difference between the top surfaces of the gasket sealing surface and the leveling strip or the high point.

18. The method of claim 17, wherein using a water level test to determine whether the top surface of the gasket sealing surface or the leveling strip is level within a predetermined tolerance between opposing ends thereof comprises:
adding water to an underdrain basin until the water level reaches the lowest point on the top surface of the leveling strip;
determining a height difference between the lowest point and a highest point on the top surface of the leveling strip; and
determining whether the height difference is within a predetermined tolerance.

19. The method of claim 17, wherein using a water level test to determine whether the top surface of the leveling strip is level within a predetermined tolerance between opposing lateral sides thereof comprises:
adding water to an underdrain basin until the water level reaches the highest point on the top surface of the leveling strip;
determining whether the water covers a portion of the top surface of the leveling strip; and
determining whether the covered portion is within a predetermined tolerance.

20. The method of claim 17, wherein using a water level test to determine a height difference between the top surfaces of the leveling strip and the grout seal strip comprises:
adding water to an underdrain basin until the water level reaches the top surface of the leveling strip;
determining a height difference between the top surface of the leveling strip and the top surface; and
determining whether the height difference is within a predetermined tolerance.
